(19) United States
(12) Patent Application Publication
(10) Pub. No.: US 2021/0350249 A1
(43) Pub. Date: Nov. 11, 2021

(54) AGRICULTURAL ASSISTANCE SYSTEM

(71) Applicant: CLAAS Tractor SAS, Vélizy-Villacoublay Cedex (FR)

(72) Inventors: Christian Ehlert, Bielefeld (DE); Jan Carsten Wieckhorst, Uelzen Ortsteil Hanstedt 2 (DE); Christian Birkmann, Versmold (DE); Lennart Meyer, Aachen (DE)

(73) Assignee: CLAAS Tractor SAS, Vélizy-Villacoublay Cedex (FR)

(21) Appl. No.: 17/307,615

(22) Filed: May 4, 2021

(30) Foreign Application Priority Data
May 6, 2020 (DE) 102020112297.7

(51) Int. Cl. G06N 5/02; G06F 16/951; G06F 21/31; G05D 1/02

(52) U.S. Cl. CPC G06N 5/025; G06F 16/951; G05D 2201/0201; G05D 1/0212; G06F 21/31

(57) ABSTRACT

An agricultural assistance system having a driver assistance system for controlling a prime mover, such as a tractor, and/or an attachment is disclosed. The agricultural assistance system generates control parameters for the prime mover and/or for the attachment. The driver assistance system includes an input/output unit for communication with a user. The driver assistance system includes a rule interpreter that generates the control parameters by processing rules from the sets of rules. The agricultural assistance system also includes a rule generator for creating and/or editing the sets of rules, with the rule generator generating a user interface through which to create and/or edit the sets of rules. Specifically, users can create or edit the sets of rules via a browser of the rule generator. The rule generator further can include user administration functionality in which access rights of individual users to the sets of rules are defined.

### CROSS-REFERENCE TO RELATED APPLICATION

This application claims priority under 35 U.S.C. § 119 to German Patent Application No. DE 102020112297.7 filed May 6, 2020, the entire disclosure of which is hereby incorporated by reference herein.

### TECHNICAL FIELD

The present invention relates to an agricultural assistance system that includes a driver assistance system for controlling a prime mover.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2019/0183031 A1, incorporated by reference herein in its entirety, relates to an agricultural assistance system. The agricultural assistance system at issue is used to control a prime mover (e.g., a tractor) and/or an attachment that may form an agricultural combination. Thus, the attachment may be coupled to the prime mover. In so doing, one and the same tractor may be combined with a wide variety of attachments. Such attachments may, for example, be mowers, balers, hay rakes, tedders, tillage machines, manure spreaders, etc.

To optimally control the agricultural combination under specific optimization criteria, the prime mover is assigned a driver assistance system. With such a driver assistance system, it is important to be cognizant of certain properties of the prime mover and certain properties of the attachment in order to optimally control the combination.

Control parameters for the prime mover and/or for the attachment may be generated. Further, the driver assistance system has an input/output unit in order to interact with the operator. The generated control parameters may be sent to a machine controller of the prime mover and/or to a device controller of the attachment, if available. A change in the control parameters then causes a corresponding change in the machine settings and/or device settings. The change in the control parameters may be fully automated or be implemented through user input. In the latter case, the user may, for example, be asked by the input/output unit to make corresponding entries.

Driver assistance systems may have rule-based control. Such rule-based control systems may include a rule interpreter that is configured to process the rules in a set of rules. In such a case, the rules may be based on simple “if-then conditions”. To process the set of rules, input parameters are fed to the rule interpreter, and the rule interpreter applies the rules of the set of rules to the input parameters. The results are output parameters that result from the input parameters on the one hand and the set of rules on the other hand. The rules of the set of rules are of a standardized format so that entirely unknown rules can be processed by the rule interpreter in a reproducible manner.

The rule interpreter may comprise a generic unit that is designed independently of the design of the prime mover and attachment. The set of rules, in contrast, may be tailored, representing the prime-mover-specific and/or attachment-specific properties.

### DESCRIPTION OF THE DRAWING

The present application is further described in the detailed description which follows, in reference to the noted drawing by way of non-limiting examples of exemplary implementation wherein:

FIG. 1 shows a schematic representation of an agricultural combination with the disclosed agricultural assistance system.

### DETAILED DESCRIPTION

As discussed in the background, the set of rules may be assumed to be known in advance. However, both a centralized creation of the sets of rules and an individual, specific editing of the sets of rules by individual users may be insufficient for optimally managing the high complexity of different agricultural combinations.

Thus, in one or some embodiments, an agricultural assistance system is directed to the problem of designing and developing the agricultural assistance system to achieve further optimization with respect to the aforementioned challenge.

In one or some embodiments, an agricultural assistance system has a driver assistance system for controlling a prime mover (such as a tractor), and/or an attachment of an agricultural combination. The agricultural assistance system may generate control parameters for use by at least a part of the prime mover (such as for use by a machine controller of the prime mover) and/or for use by at least a part of the attachment (such as a device controller of the attachment). The driver assistance system includes an input/output unit for the interacting or communicating with a user. The agricultural assistance system, such as the driver assistance system, has a rule interpreter that generates the control parameters by processing rules from one or more sets of rules. In one embodiment, the rule interpreter is separate from but associated with the driver assistance system. In an alternate embodiment, the rule interpreter is included as part of the driver assistance system.

The agricultural assistance system may include a rule generator for creating and/or editing the one or more sets of rules. The rule generator may provide or generate a user interface through which the one or more sets of rules may be created and/or edited by one or more users. One example user interface may be based on a browser. The rule generator may further have a user administration function in which access rights of individual users (such as an indication that indicates the access rights) to at least part of the set the rules may be defined.

In one or some embodiments, the rule generator may transmit the one or more sets of rules to the rule interpreter, so that the rule interpreter may process the one or more sets of rules via a dialog (e.g., communication or interaction) with a user. In particular, a set of rules may be created and/or edited by the user via the rule generator through the user interacting via the user interface.

In a particular example, a first group of users of one or more sets of rules, which were created by second group of users, may transmit agricultural combinations assigned to them from the rule generator to the rule interpreter, such that the first group of users may edit the one or more sets of rules. Alternatively, or in addition, agricultural combinations may also be assigned to the second group of users and/or a user may release one or more sets of rules for use by other users through the user administration function for the one or more sets of rules that the user may have created or edited.

In one or some embodiments, the agricultural assistance system includes a server platform, with the server platform running the rule generator. The server platform may be used by a user assigned to the agricultural combination. For example, the user, via a browser, may create and/or edit the one or more sets of rules.

The server platform may provide a web interface as a user interface for the rule generator. For example, the web interface may display flowcharts on the one or more sets of rules. Alternatively, or in addition, the server platform may comprise a database which may have stored therein text components for dialogs assigned to the one or more sets of rules that may be used by the user to create or edit the dialog. Alternatively, or in addition, the server platform may include a preview function for the assigned dialogs.

In this way, the expertise required for the sets of rules may be distributed or represented in a decentralized manner among many users and producers of prime movers and attachments. To enable optimized controlling of the prime movers and/or attachments, it is contemplated to compile this knowledge, convert it into sets of rules and use it. It should be taken into consideration that many interests of the individual users may conflict with each other, and the required knowledge is therefore not freely available. In order to nonetheless be able to optimize the controlling of the agricultural combination, a user administration is disclosed in which access rights to this knowledge are regulated or monitored in the form of one or more sets of rules.

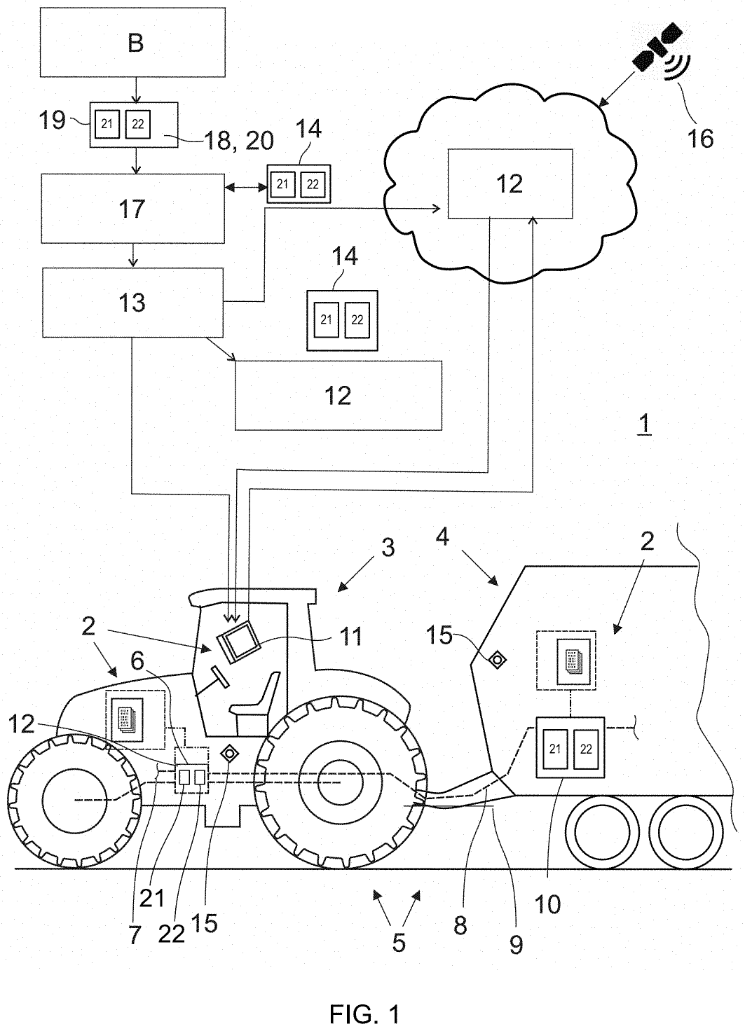

Referring to the figure, FIG. 1 shows a schematic representation of an agricultural combination with the disclosed agricultural assistance system 1. The agricultural assistance system 1 has a driver assistance system 2. In one or some embodiments, the driver assistance system 2 is configured to control a prime mover 3, such as a tractor, and/or an attachment 4 of an agricultural combination 5.

The attachment 4 may be any type of attachment that may be coupled to a prime mover 3. In the disclosed embodiment, the attachment 4 is a baler with which hay, straw, etc. can be pressed into bales. Other attachments are contemplated.

The prime mover 3 includes a machine controller 6 with which machine settings such as any one, any combination, or all of the rotational speed of the prime mover motor 7, the rotational speed or the torque of the power takeoff shaft 8 of the prime mover 3, the lift height of a rear power lift 9, etc. may be changed. In one or some embodiments, the machine controller 6 is supplied the control parameters generated by the agricultural assistance system 1.

The machine controller 6 may comprise any type of computing functionality, such as at least one processor 21 (which may comprise a microprocessor, controller, PLA, or the like) and at least one memory 22. The memory may comprise any type of storage device (e.g., any type of memory). Though the processor 21 and memory 22 are depicted as separate elements, they may be part of a single machine, which includes a microprocessor (or other type of controller) and a memory.

The processor 21 and memory 22 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the attachment 4 is also equipped with its own control functionality, such as device controller 10 that is fed one or more control parameters generated by the agricultural assistance system 1. Similar to machine controller 6, device controller 10 may include at least one processor 21 and at least one memory 22. In one embodiment, the computing functionality for machine controller 6 is identical to device controller 10. Alternatively, the computing functionality for machine controller 6 is different from device controller 10. This supplying of the control parameters to the device controller 10 may be performed automatically or responsive to input by an operator B (e.g., the operator B changes the control parameters through an input/output unit 11, or enters them through an input/output unit 11).

Thus, the agricultural assistance system 1 may generate control parameters for one or both of the prime mover 3 (such as for machine controller 6 of the prime mover 3), and/or for the attachment 4 (such as for a device controller 10 of the attachment 4). The driver assistance system 2 has an input/output unit 11 for the dialog with an operator B, wherein the agricultural assistance system 1, such as the driver assistance system 2 of the agricultural assistance system, includes a rule interpreter 12 that generates the control parameters by processing rules from one or more sets of rules 13.

In one or some embodiments, the input/output unit 11 may be arranged or positioned on the prime mover 3. Alternatively, or in addition, the input/output unit 11 may be part of mobile device 14. In one or some embodiments, mobile device 14 may include computing functionality, such as processor 21 and memory 22. The driver assistance system 2 may, as shown in FIG. 1, be arranged or positioned on at least a part of the agricultural combination 5, such as on the prime mover 3.

The rule interpreter 12 is configured to generate the control parameters from the one or more sets of rules 13 that may contain a variety of different rules. The one or more sets of rules 13 may affect or control one or more aspects of the prime mover 3, the attachment 4 and/or the agricultural combination 5. Further, the one or more sets of rules 13 may be directed to different input data comprising (or consisting of) sensors 15 and external sources 16 and have different complexities.

The agricultural assistance system 1 may include a rule generator 17 for creating and/or editing the one or more sets of rules 13. In one or some embodiments, in order to create and/or edit the one or more sets of rules 13, the rule generator 17 generates a user interface 18 through which the one or more sets of rules 13 may be created and/or edited by one or more users B. For example, the user interface 18 may comprise a browser through which creating and/or editing of the one or more rules may be accomplished. Further, the rule generator 17 may include user administration functionality in which access rights of individual users B (as defined by an indication of access rights) to at least part of the set the rules 13 are defined (e.g., the rule generator 17 may determine whether a specific user B has permission to create and/or edit the one or more rules via the user administration functionality).

In one or some embodiments, the rule generator 17 may be configured to create and/or edit the one or more sets of rules 13 and include functionality to transmit them to the rule interpreter 12. In one or some embodiments, the user interface 18 may comprise a website that may be accessed via a typical Internet browser. In one or some embodiments, the rule generator 17, using its user administration functionality, may regulate access by a particular user B to the one or more sets of rules 13 (e.g., access to the website may be determined by the user administration functionality of the rule generator 17 so that the particular user B may be given access to the website to create and/or edit the one or more sets of rules 13 responsive to the user administration functionality determining access should be granted).

In one or some embodiments, the user B may create and/or edit his/her own and/or common sets of rules 13. In a more specific embodiment, the users B may log on, for example, to the rule generator 17 with a password and a username through the user interface 18. Responsive to the rule generator 17 granting access (based on the password and username entered), the users B may then edit the one or more sets of rules 13 that the users B are entitled to access and create additional sets of rules 13. For example, a database may have stored therein identification for a particular user B, such as in the form of his/her username/password, correlated with the specific set(s) of rules 13 that the particular user B is entitled to access/edit and/or specific actions that the particular user B may perform, including creating and/or editing. In practice, the user may enter his/her username/password or other type of user information. The rule generator 17 may compare the username/password stored in the database with that provided by the user. If there is a match, the rule generator 17 generate, via the input/output unit, a user interface (such as a browser interface) through which the user may enter rules information in order to perform one or both of creating or editing the one or more sets of rules. Responsive to receiving the rules information (entered via the browser interface), the rule generator may perform one or both of creating or editing the one or more sets of rules.

In one or some embodiments, the particular user B may set access rights to part or all of his/her sets of rules 13, with the access rights indicating to the rule generator 17 whether to enable one or more other users access to edit and/or deny others access to edit. In one or some embodiments, the particular user B may indicate to the rule generator 17 whether some or all of the one or more sets of rules associated with the particular user B may be published or sold (e.g., in one embodiment, the particular user B may initially indicate that the one or more sets of rules associated with the particular user B may published or sold; after which, the one or more sets of rules associated with the particular user B may be published or sold without further input from the particular user B; alternatively, the rule generator 17 may contact the particular user B to request approval from the particular user B prior to publishing or selling part or all of the one or more sets of rules associated with the particular user B, such as allowing another user access in order to edit the one or more sets of rules). In this regard, the rule generator 17 may assist in publishing and/or selling the one or more sets of rules 13. By this type of cooperation, it is made possible for the users B to optimize their agricultural combination 5 based on the knowledge of many other users B. In one or some embodiments, the access rights (such as the settings enabling access, publication, and/or sale) are saved in a database.

In one or some embodiments, the one or more sets of rules 13 are transmitted by the rule generator 17 to the rule interpreter 12, such that the one or more sets of rules 13 are processed by the rule interpreter 12 in a dialog with a user B. In particular, the dialog, which may comprise the user interface 18 through which the user B may interact with the rule interpreter 12, enables the user B to create and/or edit the one or more sets of rules 13.

In one or some embodiments, a dialog with the user B comprises the displaying of information to the user B including any one, any combination, or all of a question, a selection option, an input option, etc. in response to which, the user B may provide or offer a standardized response. The response of the user B may then be used by the rule interpreter 12 in the context of processing the one or more sets of rules 13. In one or some embodiments, the dialog comprises several such user entries. The rule interpreter 12 may comprise a generic unit which may be executed independently of location on basically any type of control hardware. In this regard, in one or some embodiments, several rule interpreters 12 may be present in different locations. Thus, a sole rule generator 17 may be resident in a central location (so that the agricultural assistance system consists of a single rule generator 17), such as the server platform, whereas the rule interpreters 12 may be decentralized (and may reside in several different locations, such as several different geographic locations so that the plurality of rule interpreters 12 are resident in a plurality of prime movers, a plurality of attachments, or in a plurality of agricultural combinations of prime movers and tractors).

Moreover, in one or some embodiments, a first group of users B may be granted access to the one or more sets of rules 13 created by second group of users B (e.g., the second group of users B may indicate that the first group of users B may be granted access or may indicate that any user may be granted access). In turn, the first group of users B may transmit agricultural combinations 5 assigned to them from the rule generator 17 to the rule interpreter 12, so that the first group of users B may edit the one or more sets of rules 13 created by the second group of users B, and/or that agricultural combinations 5 are also assigned to the second group of users B, and/or that a user B may release one or more sets of rules 13 for other users B (through the user administration functionality) that he/she may have created or edited.

The assignment of the agricultural combinations 5 to the users B may relate to an ownership status. However, it may also constitute a usage or another assignment. In one or some embodiments, the assignment is saved in a database of the agricultural assistance system 1 and defined in this regard. In one or some embodiments, higher level assignments may also be provided, for example through cooperations between users B. In such a case, these assignments are all defined in the database of the agricultural assistance system 1 and may also only be relevant to the user administration within the defined framework. The user B may, accordingly, for example control his agricultural combinations 5 with sets of rules 13 from other users B.

To accomplish this, the rule generator 17 may provide the one or more sets of rules 13 as needed to the rule interpreter 12, such as independent of the location at which it is run.

Moreover, in such a case, it is provided that the agricultural assistance system 1 has a server platform 19. In particular, the server platform 19 may run the rule generator 17, and with the server platform 19 being used by a user B assigned to the agricultural combination 5 (e.g., based on a browser, the user B may create and/or edit the one or more sets the rules 13).

The server platform 19 may comprise at least hardware and computing capacity for running the rule generator 17. Similar to machine controller 6 and device controller 10, the server platform 19 may comprise at least one processor 21 and at least one memory 22. In this regard, any discussion regarding machine controller 6 or device controller 10 may be applied to server platform 19.

In one or some embodiments, the server platform 19 is configured to provide a web interface 20 as a user interface 18 for the rule generator 17 (e.g., flowcharts on the sets of rules 13 can be displayed via the web interface 20), and/or that the server platform 19 comprises a database which may include text components for dialogs assigned to the one or more sets of rules 13 that may be used by the user B to create and/or edit the dialog, and/or that the server platform 19 has a preview function for the assigned dialogs.

In one or some embodiments, the web interface 20 comprises a website with access to a database on the server platform 19. In this case, the one or more sets of rules 13 and the dialogs may be edited and/or created to a great extent. In so doing, any one, any combination, or all of the following can be provided: drag-and-drop functionalities; encoding options; options for saving; downloading; duplicating; referencing and publishing; or preview functions.

Further, it is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural assistance system
2 Driver assistance system
3 Prime mover
4 Attachment
5 Agricultural combination
6 Machine controller
7 Prime mover motor
8 Power take-off shaft
9 Rear power lifter
10 Device controller
11 Input/output unit
12 Rule interpreter
13 List of rules
14 Mobile device
15 Sensors
16 External sources
17 Rule generator
18 User interface
19 Server platform
20 Web interface
21 Processor
22 Memory
B User

1. An agricultural assistance system comprising a driver assistance system configured to control one or both of a prime mover or an attachment attached to the prime mover, the agricultural assistance system comprising:
an input/output unit for communicating with a user;
a rule generator configured to:
store access rights of one or more users to part or all of one or more sets of rules;
receive, via the input/output unit, user information;
responsive to determining whether to grant access based on the user information and the access rights, generate, via the input/output unit, a user interface through which the one or more users enter rules information in order to perform one or both of creating or editing the one or more sets of rules; and
responsive to the rules information entered, perform the one or both of creating or editing the one or more sets of rules; and
a rule interpreter configured to access the one or more rules and to generate, based on the one or more rules, one or more control parameters to control the one or both of the prime mover or the attachment attached to the prime mover.

2. The agricultural assistance system of claim 1, wherein the user interface is created via a browser.

3. The agricultural assistance system of claim 1, wherein the rule generator is configured to transmit the one or more sets of rules to the rule interpreter; and
wherein the rule interpreter is configured to process the one or more sets of rules.

4. The agricultural assistance system of claim 3, wherein the rule interpreter is configured to perform the one or both of creating or editing the one or more sets of rules via a dialog with a user.

5. The agricultural assistance system of claim 4, wherein the rule interpreter is configured to:
assign the dialog to a specific set of rules; and
one or both of create or edit, via the dialog and using the user interface, the specific set of rules.

6. The agricultural assistance system of claim 5, wherein the dialog comprises at least one of a question, a selection option, or an input option.

7. The agricultural assistance system of claim 1, wherein the rule generator is further configured to:
receive, from a user that created a specific set of rules, an indication of access rights for other users to edit the specific set of rules; and
responsive to one of the other users requesting to edit the specific set of rules, determine whether to grant access to the one of the other users based on the indication of access rights.

8. The agricultural assistance system of claim 7, wherein the indication of access rights is indicative of the specific set of rules to be published or sold; and
wherein, responsive to the rule generator determining that the specific set of rules is to be published or sold, the rule generator is configured to grant access to the one of the other users without further input from the user.

9. The agricultural assistance system of claim 7, wherein the indication of access rights is indicative of the user being contacted before the specific set of rules is to be published or sold; and
wherein, responsive to the rule generator determining that the specific set of rules is indicative of the user being contacted before the specific set of rules is to be published or sold, the rule generator is configured to contact the user to request approval prior to publishing or selling part or all of the specific set of rules.

10. The agricultural assistance system of claim 1, wherein the rule generator is resident in a server; and
wherein the agricultural assistance system includes a plurality of rule interpreters decentralized from the server and residing in a plurality of different geographic locations.

11. The agricultural assistance system of claim 10, wherein the plurality of rule interpreters are resident in a plurality of prime movers, a plurality of attachments, or in a plurality of agricultural combinations of prime movers and tractors.

12. The agricultural assistance system of claim 10, wherein the agricultural assistance system consists of a single rule generator resident in the server; and
wherein the plurality of rule interpreters are configured for execution independently of the plurality of different geographic locations.

13. The agricultural assistance system of claim 1, wherein the rule generator is resident on a server platform; and
wherein the rule generator is configured to receive the rules information via a browser in order to perform the one or both of creating or editing the one or more sets of rules.

14. The agricultural assistance system of claim 13, wherein the server platform is configured to provide a web interface as the user interface for the rule generator.

15. The agricultural assistance system of claim 14, wherein the server platform is configured to display flowcharts on the one or more sets of rules via the web interface.

16. The agricultural assistance system of claim 14, wherein the server platform comprises a database including text components for dialogs assigned to the one or more sets of rules stored therein; and
wherein the server platform is configured to use the text components to create or edit the dialog in order to enable the user to provide the rules information to perform the one or both of creating or editing the one or more sets of rules.

17. The agricultural assistance system of claim 16, wherein the server platform includes a preview function for the assigned dialogs.
